(19) United States
(12) Patent Application Publication
(10) Pub. No.: US 2025/0139143 A1
(43) Pub. Date: May 1, 2025

(54) INFORMATION OUTPUT APPARATUS, INFORMATION OUTPUT METHOD, AND NON-TRANSITORY COMPUTER-READABLE MEDIUM

(71) Applicant: NEC Corporation, Tokyo (JP)

(72) Inventors: Shinnosuke NISHIMOTO, Tokyo (JP); Genki KUSANO, Tokyo (JP)

(73) Assignee: NEC Corporation, Tokyo (JP)

(21) Appl. No.: 18/921,078

(22) Filed: Oct. 21, 2024

(30) Foreign Application Priority Data
Nov. 1, 2023 (JP) 2023-187495

(51) Int. Cl. G06F 16/335; G06F 16/383

(52) U.S. Cl. CPC G06F 16/337; G06F 16/383

(57) ABSTRACT

In order to achieve that a mode in which information is provided is changed for each person, an information output apparatus includes a first acquisition unit, a second acquisition unit, a third acquisition unit, and an output unit. The first acquisition unit acquires subject information including a text. The second acquisition unit acquires attribute information of a user. The third acquisition unit inputs the attribute information and the subject information to a generative model, and acquires, from the generative model, provision information that is information based on the subject information and is to be provided to the user. The output unit outputs the provision information.

This application is based upon and claims the benefit of priority from Japanese patent application No. 2023-187495, filed on Nov. 1, 2023, the disclosure of which is incorporated herein in its entirety by reference.

### BACKGROUND

### Technical Field

The present invention relates to an information output apparatus, an information output method, and a non-transitory computer-readable medium.

### Background Art

In recent years, it is possible to acquire various pieces of information by using a communication apparatus. For example, the following social networking service is disclosed in International Patent Publication No. WO2020/136760. The social networking service includes a first user who has authority to add a comment to article information and a second user who does not have the authority to add a comment. In a case of receiving, from the second user, a request for generating article information, a server enables the transmission, to a terminal of the first user and/or the second user, of article information to be displayed on a terminal of a user and period information related to a period in which the first user can add a comment to an article. Next, the server generates an archive by storing the article information including a comment, at an interval shorter than the period based on the period information. Next, the server enables the transmission, to the terminal of the first and/or second user, of the whole or part of the article information stored in the archive, in response to a request from the first and/or second user.

### SUMMARY

At a time when providing specific information to a person, an appropriate mode in which the information is provided is considered to be different for each person. According to the technique described in the above-described International Patent Publication No. WO2020/136760, a mode in which information is provided cannot be changed for each person. One example of a problem to be solved by the present disclosure is to enable a mode in which information is provided to be changed for each person.

In one example aspect of the invention, there is provided an information output apparatus comprising:
a first acquisition unit that acquires subject information including a text,
a second acquisition unit that acquires attribute information of a user;
a third acquisition unit that inputs the attribute information and the subject information to a generative model, and acquires, from the generative model, provision information that is information based on the subject information and is to be provided to the user; and
an output unit that outputs the provision information.

In another example aspect of the invention, there is provided an information output method comprising,
by at least one computer:
   acquiring subject information including a text;
   acquiring attribute information of a user;
   inputting the attribute information and the subject information to a generative model;
   acquiring, from the generative model, provision information that is information based on the subject information and is to be provided to the user; and
   outputting the provision information.

In still another example aspect of the invention, there is provided a non-transitory computer-readable medium storing a program causing at least one computer to perform operations comprising:
acquiring subject information including a text;
acquiring attribute information of a user;
inputting the attribute information and the subject information to a generative model;
acquiring, from the generative model, provision information that is information based on the subject information and is to be provided to the user; and
outputting the provision information.

An example advantage according to the example aspect of the invention is that a mode in which information is provided can be changed for each person.

### BRIEF DESCRIPTION OF THE DRAWINGS

The above and other objects, advantages and features of the present invention will be more apparent from the following description of certain preferred example embodiments taken in conjunction with the accompanying drawings, in which:

FIG. 1 is a block diagram illustrating a configuration example of an information output apparatus according to the present disclosure;

FIG. 2 is a flowchart illustrating a processing operation example of the information output apparatus according to the present disclosure;

FIG. 3 is a diagram illustrating an example of a usage environment of the information output apparatus according to the present disclosure;

FIG. 4 is a block diagram illustrating a configuration example of the information output apparatus according to the present disclosure;

FIG. 5 is a diagram for describing one example of processing performed by a second acquisition unit according to the present disclosure;

FIG. 6 is a diagram for describing another example of processing performed by the second acquisition unit according to the present disclosure;

FIG. 7 is a diagram for describing one example of processing performed by a third acquisition unit according to the present disclosure;

FIG. 8 is a diagram describing one example of a hardware configuration of the information output apparatus according to the present disclosure;

FIG. 9 is a flowchart illustrating a processing operation example of the information output apparatus according to the present disclosure;

FIG. 10 is a diagram illustrating one example of a screen according to an output from an output unit according to the present disclosure;

FIG. 11 is a diagram illustrating one example of a screen according to an output from the output unit according to the present disclosure;

FIG. 12 is a diagram illustrating one example of a screen according to an output from the output unit according to the present disclosure; and

FIG. 13 is a flowchart illustrating a processing operation example of the information output apparatus according to the present disclosure.

### EXAMPLE EMBODIMENT

The invention will be now described herein with reference to illustrative example embodiments. Those skilled in the art will recognize that many alternative example embodiments can be accomplished using the teachings of the present invention and that the invention is not limited to the example embodiments illustrated for explanatory purposes.

In the following, in the present disclosure, the drawings are related to one or more example embodiments. Further, in all the drawings, a similar component is denoted with a similar reference sign, and description thereof is omitted as appropriate.

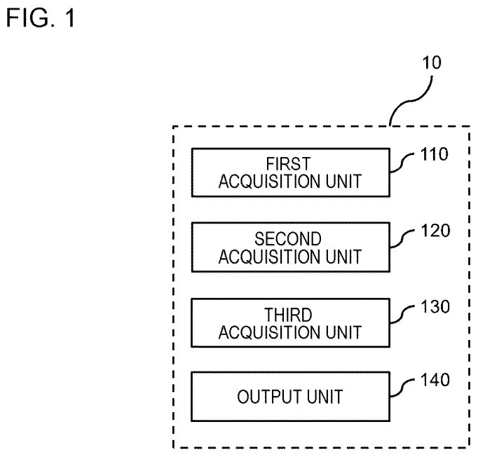

As illustrated in FIG. 1, an information output apparatus 10 according to the present disclosure includes a first acquisition unit 110, a second acquisition unit 120, a third acquisition unit 130, and an output unit 140. The first acquisition unit 110 acquires subject information including a text.

Hereinafter, this text is referred to as a subject text. The second acquisition unit 120 acquires attribute information of a user. The third acquisition unit 130 inputs the attribute information and the subject information to a generative model, and acquires, from the generative model, provision information that is information based on the subject information and is to be provided to the user. The output unit 140 outputs the provision information.

The subject information may include information published via a communication line, for example. One example of such subject information is news or an interpretive article on a subject, but is not limited thereto. The subject of the interpretive article is at least one of an event, news, an object, a service, and a product, but is not limited thereto. Further, the subject information may be an advertisement to be provided to a user. Note that, the subject information may be information other than those described above.

The attribute information of a user may include various items. For example, the attribute information of a user may include an item related to at least one of gender, an age group, an occupation, preference in shopping and dining, and a hobby.

The generative model is, for example, an interactive generative model, and in a case where a subject text included in the subject information is input, generates a text based on the subject text. Hereinafter, the text is referred to as a generated text. In the information output apparatus 10, at least a part of the generated text is handled as at least a part of the provision information. As described above, an input to the generative model includes the attribute information of a user. Therefore, at least a part of the provision information changes depending on the attribute information of a user.

The above-described generative model may be included in the information output apparatus 10, or may be included in an apparatus external to the information output apparatus 10. In the latter case, the information output apparatus 10 communicates with the external apparatus.

The provision information may include, for example, revised information being revised or paraphrased from input information, or may include supplementary information that supplements the input information. In other words, information in the generated text which is to be included in the provision information may be the revised information, or may be the supplementary information.

One example of the revised information is a text made by processing the subject text included in the subject information, according to an attribute of a user. As one example, the generative model selects, based on the subject information and the attribute of a user, information to be added to the subject information, and generates the revised information by adding a text indicating the selected information to the subject information. As another example, the generative model identifies, based on the attribute of a user, a portion to be revised in the subject text, and generates the revised information by revising expression of the identified portion. Since the revised information includes a text revised from the subject text by using the attribute of a user, a user can understand information more easily than a case of reading the subject text included in the subject information without revision.

One example of the supplementary information is information being provided together with the input information, for example, information that explains the input information, or information to be referred to by a user at a time when interpreting the input information. For example, in a case where the input information is news, the supplementary information includes a text that explains the news. Further, in a case where the input information includes a noun, for example, a name of an object such as a product, or a service, the supplementary information includes a text that explains the object or the service indicated by the noun. In this case, since being able to refer to the supplementary information, a user can easily understand the subject information.

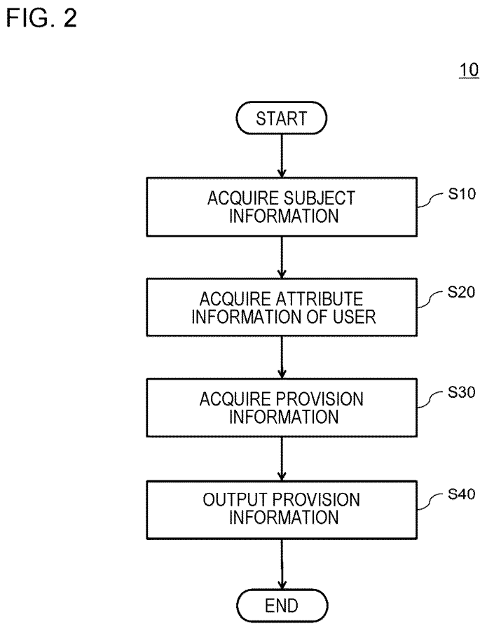

The information output apparatus 10 operates, for example, as illustrated in FIG. 2. First, the first acquisition unit 110 acquires subject information (step S10). Next, the second acquisition unit 120 acquires attribute information of a user (step S20). The third acquisition unit 130 inputs the attribute information and the subject information to a generative model, and acquires provision information from the generative model (step S30). Next, the output unit 140 outputs the provision information (step S40).

With the information output apparatus 10, at a time when provision information is generated, attribute information of a user and subject information is input to a generative model. Therefore, a mode in which information is provided can be changed for each user.

In the following, a detailed example of the information output apparatus 10 is described.

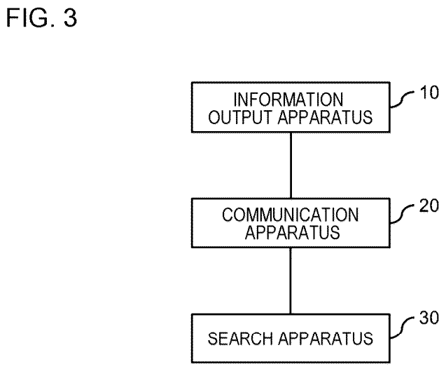

In an example illustrated in FIG. 3, the information output apparatus 10 is used together with a communication apparatus 20 and a search apparatus 30. The information output apparatus 10 and the communication apparatus 20 are connected with each other via a communication line, and the communication apparatus 20 and the search apparatus 30 are also connected with each other via a communication line. The communication line connecting the information output apparatus 10 and the communication apparatus 20 with each other may be a public communication network such as the Internet, a local network, or a dedicated line. Further, the communication line connecting the communication apparatus 20 and the search apparatus 30 with each other may also be a public communication network such as the Internet, a local network, or a dedicated line.

The communication apparatus 20 is operated by a user. One example of the communication apparatus 20 is a portable communication apparatus such as a smartphone and a tablet terminal. The communication apparatus 20 includes, for example, a browser. A user inputs, for example, a search criterion to the browser. The communication apparatus 20 transmits the search criterion to the search apparatus 30.

The search apparatus 30 retrieves the subject information, according to the search criterion which a user has input to the communication apparatus 20, and transmits the retrieved information to the communication apparatus 20. At least a part of the retrieved information is at least a part of the subject information. One example of the search apparatus 30 is an apparatus that performs search processing according to the search criterion input from the browser, but is not limited thereto. The search apparatus 30 may be configured of a plurality of search servers.

In a case of searching for news, the search apparatus 30 may use Web scraping, or may use a database storing a plurality of pieces of news. One example of the database is a Newspaper3k library and a news-fetch library.

The information output apparatus 10 may serve as the search apparatus 30, or the communication apparatus 20 may serve as the search apparatus 30.

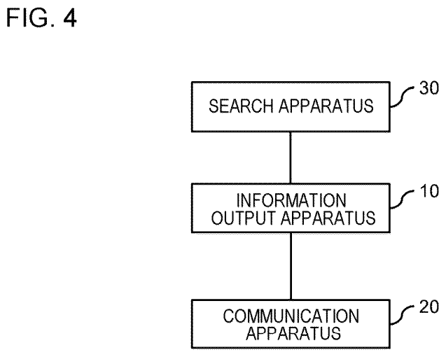

Note that, as exemplified in FIG. 4, the communication apparatus 20 may communicate with the search apparatus 30 via the information output apparatus 10. In this case, the communication line connecting the information output apparatus 10 and the communication apparatus 20 with each other may be a public communication network such as the Internet, or a local network. Further, the communication line connecting the information output apparatus 10 and the search apparatus 30 with each other may also be a public communication network such as the Internet, or a local network.

Next, detailed examples of the first acquisition unit 110, the second acquisition unit 120, the third acquisition unit 130, and the output unit 140 included in the information output apparatus 10 are described.

### (Detailed Example of First Acquisition Unit 110)

The first acquisition unit 110 acquires the subject information. As one example, the first acquisition unit 110 acquires, via the browser of the communication apparatus 20, the subject information transmitted from the search apparatus 30 to the communication apparatus 20. On this occasion, the first acquisition unit 110 may acquire the search criterion being input to the browser of the communication apparatus 20.

Note that, the first acquisition unit 110 may acquire the subject information from a database storing a plurality of pieces of information. In this case, the first acquisition unit 110 may not use the browser as an intermediate at a time when acquiring the subject information. One example of the database used herein is the above-described database storing news.

However, the database may be a database storing advertisement information by each product or service. In this case, the first acquisition unit 110 acquires specification information for specifying a product or a service, and reads advertisement information related to the specification information, from the database. Note that, the specification information for specifying a product or a service may be input, for example, by a user, to the communication apparatus 20, as the search criterion, and then may be transmitted from the communication apparatus 20 to the information output apparatus 10. Further, the specification information may be specified by the information output apparatus 10 or an apparatus different from the information output apparatus 10, based on at least one of an attribute of a user, a product or a service that the user intends to purchase this time, a purchase history of the user, and a search history of the user.

### (Detailed Example of Second Acquisition Unit 120)

The second acquisition unit 120 acquires the attribute information of a user. As one example, the second acquisition unit 120 acquires user information including at least one of information associated with an SNS account related to a user, a search log of information by the user, and a transaction history of the user, and generates the attribute information by using the user information. Hereinafter, this processing may be referred to as expansion processing.

First, an example of a method in which the second acquisition unit 120 acquires the user information will be described. For example, the second acquisition unit 120 acquires at least a part of information being input to the communication apparatus 20, as at least a part of the user information.

As one example, the second acquisition unit 120 acquires, as at least a part of the search log, information which a user inputs to the browser of the communication apparatus 20. As another example, the second acquisition unit 120 acquires an SNS account being input to the communication apparatus 20 by a user, and acquires information associated with the account, for example, at least one of gender, age, and an occupation, as at least a part of the user information.

As another example, the second acquisition unit 120 acquires a history of transaction made by a user on an electronic commerce (EC) site, and acquires the transaction history, as at least a part of the user information. Herein, one example of the transaction history is a purchase history, but is not limited thereto. For example, the second acquisition unit 120 may collect the user information from an existing database or service, such as a purchase history (transaction data) recorded in a customer relationship management (CRM) system and a financial institution, by using an API.

Note that, the second acquisition unit 120 may use at least a part of the user information described above, as the attribute information.

Next, a method in which the second acquisition unit 120 generates the attribute information by using the user information is described.

As a first example, the second acquisition unit 120 acquires the user information of each of a plurality of users, and generates at least a part of the attribute information of at least one user by using the plurality of pieces of the user information. As one example, the second acquisition unit 120 clusters a plurality of users by using pieces of the user information, and generates the attribute information of the user by using a result of the clustering. In this case, the second acquisition unit 120 clusters a plurality of users into a plurality of groups by using algorithm such as K-means and hierarchical clustering. Herein, a plurality of users belonging to a same group are similar to each other in the user information. Further, information that characterizes each of the groups is set as the attribute information of a user belonging to the group.

For example, in a case where the user information is a purchase history, the second acquisition unit 120 identifies a frequently purchased product in each group, and generates the attribute information of a user, based on the identified product. The attribute information generated herein is, for example, that a user is highly health-conscious, prefers a nonessential grocery item such as snack food and fast food, and the like.

According to the first example, the second acquisition unit 120 can easily generate the attribute information.

As a second example, in a case where the user information includes a text, the second acquisition unit 120 generates a related character string from a subject character string included in the text, and generates the attribute information by using the generated related character string.

For example, the second acquisition unit 120 generates, from the subject character string included in the text, the related character string related to the subject character string, by using a language model that has learned a relationship between words. The language model used herein is a model that has learned a relationship between words, and is a model that generates, from a subject character string, a related character string related to the subject character string. By using the language model that has leaned sentences and writings in various contexts, the second acquisition unit 120 can generate the related character string with a valid content related to the subject character string.

A first example of the language model is a model that has learned in such a way as to output at least one sentence including an input character string. By using such a language model, the second acquisition unit 120 can generate, as the related character string, at least one sentence including the subject character string. The sentence generated in this way is related to subject data due to including the subject character string, and also includes new information related to the subject data. In this case, the second acquisition unit 120 can extract at least a part of the new information, as at least a part of the attribute information.

Such a language model may be generated by using, for example, Generative Pre-Trained Transformer-2 (GPT-2) or GPT-3 that outputs a sentence including an input character string by predicting a character string that has a high probability of being subsequent to the input character string. In addition to these, for example, a model such as Text-to-Text Transfer Transformer (T5) may be used as the language model.

The language model used by the second acquisition unit 120 may be included in the information output apparatus 10, or may be included in an apparatus external to the information output apparatus 10. In the latter case, the second acquisition unit 120 transmits a query to the external apparatus, and acquires the related character string from the external apparatus.

In a case where the language model as described above is used, the second acquisition unit 120 may re-input a character string being output from the language model to the language model. Further, this processing may be repeated a plurality of times. Thereby, an amount of pieces of information included in the subject character string can be increased, and a possibility that the attribute information being valid is extracted can be increased.

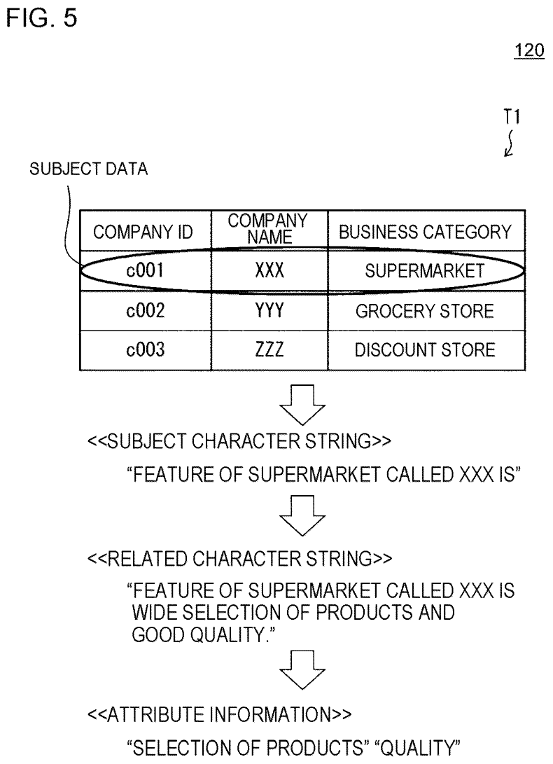

The second acquisition unit 120 performs processing, for example, as illustrated in FIG. 5. A table T1 illustrated in FIG. 5 indicates, as one example of the user information, a store that frequently used by a user. A record with a company ID “c001” included in the table T1 is subject data specified as a subject for adding the attribute information. Note that, the subject data may be the entire record, or may be one piece of data included in the record. Further, it is also possible to set, as the subject data, data in any format other than a table format.

From the table T1, it is recognizable that a name of a company of which company ID is “c001” is “XXX” and a business category of the company is a “supermarket”, but other information is unknown. According to the present method, it is possible to add the attribute information for such subject data, without using a search query and the like.

First, the second acquisition unit 120 generates a subject character string related to the subject data, which is a subject for adding the attribute information. In the example in FIG. 5, a sentence “A feature of a supermarket called XXX is” including “XXX” being a character string indicating the name of a store and a “supermarket” being a related word related to the subject data is generated as the subject character string.

Next, the second acquisition unit 120 generates, from the generated subject character string, a related character string related to the subject character string, by using the language model. In the example in FIG. 5, a sentence “A feature of a supermarket called XXX is a wide selection of products and good quality.” in which a latter half of the subject character string is complemented is generated as the related character string. Further, the second acquisition unit 120 generates, as the attribute information of the user, information that the user prefers a store with a “wide selection of products” and prefers a store with “good quality”.

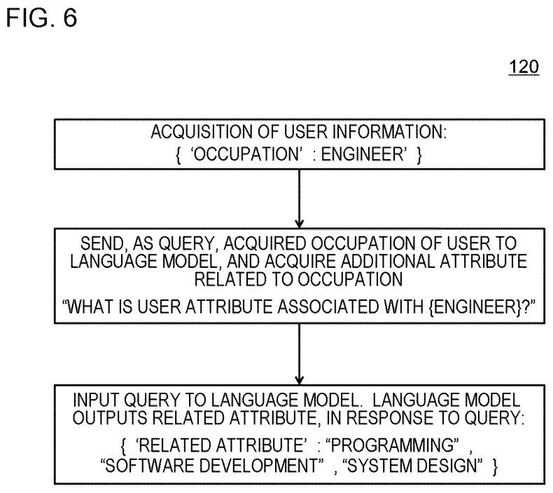

The second acquisition unit 120 may perform, for example, processing as illustrated in FIG. 6. In an example illustrated in the present diagram, the user information includes an occupation. The second acquisition unit 120 preliminarily stores a template for a query with an occupation field being blank, generates a text by fitting the occupation indicated by the user information into the template, and inputs the generated text to an interactive language model, as a query. The second acquisition unit 120 handles, as at least a part of the attribute information of the user, at least a part of information being output by the language model. In the example illustrated in FIG. 6, the language model outputs texts “programming”, “software development”, and “system design” in response to the query “What is a user attribute associated with an ‘engineer’?”. In this case, the second acquisition unit 120 handles “programming”, “software development”, and “system design” as at least a part of the attribute information of the user.

Thus, the second acquisition unit 120 expands the attribute information by performing expansion processing. Therefore, the attribute information used by the third acquisition unit 130 increases.

### (Detailed Example of Third Acquisition Unit 130)

The third acquisition unit 130 inputs a prompt including the attribute information and the subject information to a generative model, and acquires, from the generative model, the provision information that is information based on the subject information and is to be provided to a user. As described above, one example of the generative model used by the third acquisition unit 130 is an interactive generative model.

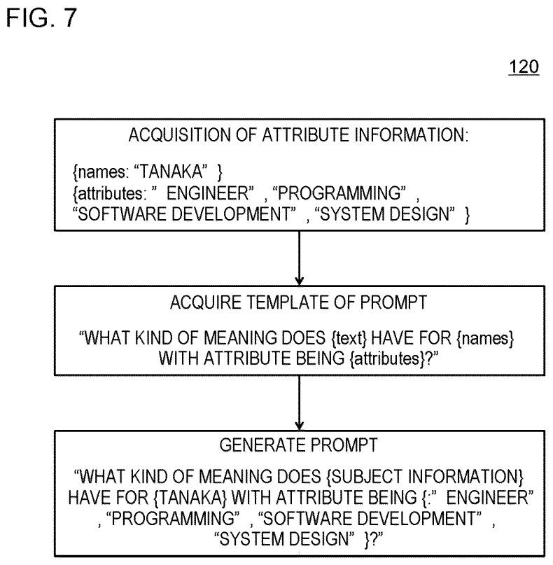

As illustrated in FIG. 7, herein, the third acquisition unit 130 may preliminarily prepare a template for a prompt with an attribute information field being blank, and generate a prompt to be input to the generative model, by fitting the attribute information into the blank field of the template.

Note that, the generative model used by the third acquisition unit 130 may be a part of the information output apparatus 10, or may be included in an apparatus external to the information output apparatus 10. In the latter case, the third acquisition unit 130 transmits the generated prompt to the external apparatus, and acquires the provision information from the external apparatus.

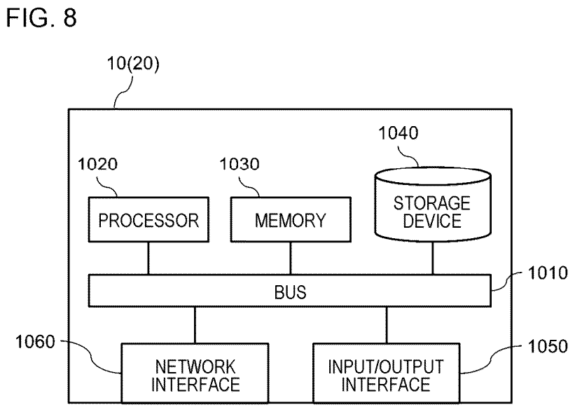

As illustrated in FIG. 8, the information output apparatus 10 includes, for example, a bus 1010, a processor 1020, a memory 1030, a storage device 1040, an input/output interface 1050, and a network interface 1060, as a hardware configuration.

The bus 1010 is a data transmission path for the processor 1020, the memory 1030, the storage device 1040, the input/output interface 1050, and the network interface 1060 to mutually transmit and receive data. However, a method for mutually connecting the processor 1020 and the like is not limited to bus connection.

The processor 1020 is a processor achieved by a central processing unit (CPU), a graphics processing unit (GPU), and the like.

The memory 1030 is a main storage apparatus achieved by a random access memory (RAM) and the like.

The storage device 1040 is an auxiliary storage apparatus achieved by a hard disk drive (HDD), a solid state drive (SSD), a removable medium such as a memory card, a read only memory (ROM), or the like, and includes a storage medium. The storage medium of the storage device 1040 stores a program module that achieves each function (for example, the first acquisition unit 110, the second acquisition unit 120, the third acquisition unit 130, and the output unit 140) of the information output apparatus 10. By the processor 1020 reading each of the program modules onto the memory 1030 and executing the program module, each function related to the program module is achieved.

The input/output interface 1050 is an interface for connecting the information output apparatus 10 to various input/output devices. For example, the information output apparatus 10 may be connected with at least one of the communication apparatus 20 and the search apparatus 30 via the input/output interface 1050.

The network interface 1060 is an interface for connecting the information output apparatus 10 to a network. The network is, for example, a local area network (LAN) or a wide area network (WAN). A method in which the network interface 1060 connects to the network may be wireless connection, or may be wired connection. The information output apparatus 10 may communicate with at least one of the communication apparatus 20 and the search apparatus 30, via the network interface 1060.

As a hardware configuration, the information output apparatus 10 may be achieved using a plurality of apparatuses.

A hardware configuration of the communication apparatus 20 is also similar to the hardware configuration of the information output apparatus 10.

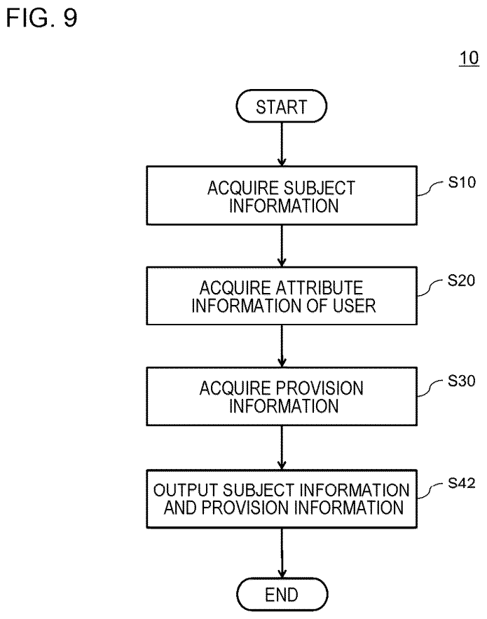

In a case where the subject information is information retrieved by using the search apparatus 30 and the provision information is the supplementary information, the information output apparatus 10 operates, for example, as illustrated in FIG. 9.

First, the first acquisition unit 110 acquires subject information (step S10). As one example, a user operates the communication apparatus 20, and thereby causes the search apparatus 30 to search for information. The communication apparatus 20 acquires the retrieved information from the search apparatus 30. The communication apparatus 20 transmits at least a part of the retrieved information to the first acquisition unit 110 of the information output apparatus 10, as at least a part of the subject information.

Next, the second acquisition unit 120 acquires attribute information of a user (step S20). One example of processing performed herein is as described by using FIGS. 5 and 6. Next, the third acquisition unit 130 inputs the attribute information and the subject information to a generative model, and acquires provision information from the generative model (step S30). One example of processing performed herein is as descried by using FIG. 7. Next, the output unit 140 outputs the subject information and the provision information (step S42). One example of an output destination of these pieces of information is the communication apparatus 20. The communication apparatus 20 causes the subject information and the provision information to be displayed. The display is performed, for example, by a display included in the communication apparatus 20.

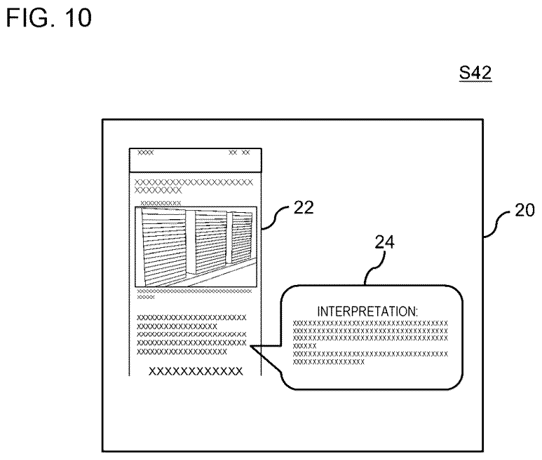

In step S42, the output unit 140 causes the communication apparatus 20 to display, for example, a screen illustrated in FIG. 10. In this example, the output unit 140 causes the display of the communication apparatus 20 to simultaneously display a first display area 22 in which the subject information is displayed and a second display area 24 in which the provision information is displayed. In other words, the output unit 140 causes at least a part of the subject information and at least a part of the provision information to be displayed in a same screen. In this way, a user can easily interpret the subject information since the user can view the subject information while referring to the provision information, that is, supplementary information.

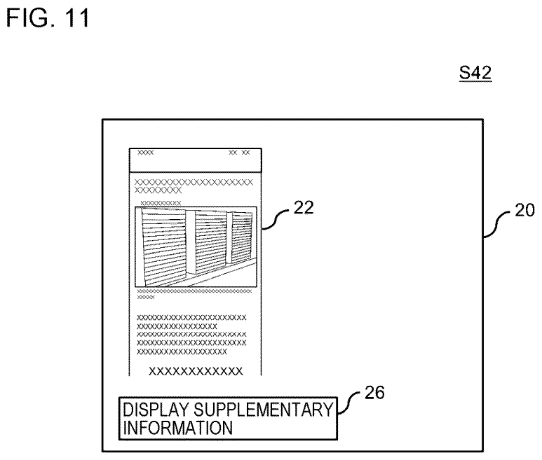

Note that, in step S42, for example, as illustrated in FIG. 11, the communication apparatus 20 may display an output button 26 together with the first display area 22 without displaying the second display area 24 illustrated in FIG. 10. In this case, the output button 26 is selected, and thereby the communication apparatus 20 displays the second display area 24 instead of the output button 26. One example of this displayed screen is a screen illustrated in FIG. 10.

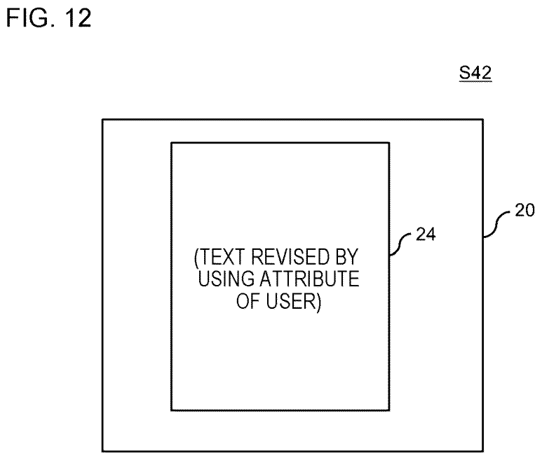

Note that, for example, as illustrated in FIG. 12, the output unit 140 of the information output apparatus 10 may cause the communication apparatus 20 to display the second display area 24 without displaying the first display area 22. In this case, the communication apparatus 20 may display the second display area 24 after displaying the first display area 22, or the communication apparatus 20 may display the provision information without displaying the subject information. In the latter case, the provision information may be either one of the supplementary information and revised information. Note that, a screen illustrated in FIG. 12 is also one example of a screen displayed by the communication apparatus 20 in step S40 in FIG. 2.

In the example illustrated in FIG. 12, the subject information may be news, or may be advertisement information. In a case of advertising information, since a subject text included in the advertising information is revised by using an attribute of a user, an advertisement effect becomes higher.

Note that, the second acquisition unit 120 may update at least a part of the attribute information to be used in next and subsequent times of processing, by using information being input by a user after the output unit 140 outputs the provision information. This input is made, for example, via the communication apparatus 20.

For example, after displaying the provision information, the communication apparatus 20 displays a screen for inputting an opinion and an impression about the provision information. A user inputs a text on this screen as needed. One example of this text is at least one of a text indicating that at least a part of information included in the provision information is unnecessary, a text indicating information being desired as the provision information, and a text directly indicating attribute information of a user.

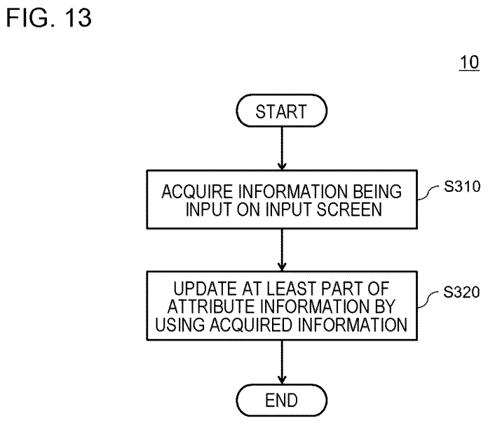

Further, as illustrated in FIG. 13, the communication apparatus 20 transmits the input information to the information output apparatus 10 (step S310). The second acquisition unit 120 of the information output apparatus 10 updates at least a part of the attribute information by using the information acquired from the communication apparatus 20 (step S320). For example, in a case where the acquired information indicates that at least a part of information included in the provision information is unnecessary, the second acquisition unit 120 deletes attribute information related to the unnecessary information. Further, in a case where the acquired information includes information being desired as the provision information, the second acquisition unit 120 adds attribute information related to the information. Further, in a case where the acquired information directly indicates attribute information of a user, the second acquisition unit 120 adds the information to the attribute information.

For example, in a case where the information acquired in step S310 includes a text “I want to know how to manage assets well”, the second acquisition unit 120 adds an item “interested in asset management” to the attribute information of a user. Further, in a case where the attribution information of a user includes an item “interested in real estate” and the information acquired in step S310 includes a text “I have no interest in real estate”, the second acquisition unit 120 deletes the item “interested in real estate” from the attribute information of the user.

In this way, accuracy of the attribute information used by the third acquisition unit 130 is improved, and therefore usefulness of the provision information becomes higher.

As described above, the information output apparatus 10 includes the third acquisition unit 130. The third acquisition unit 130 inputs attribute information and subject information to a generative model, and acquire provision information from the generative model. Therefore, by using the information output apparatus 10, a mode in which information is provided can be changed for each user.

While the present disclosure has been described above with reference to the example embodiment, the present disclosure is not limited to the above-described example embodiment. Various modifications that can be understood by a person skilled in the art can be made to a configuration and a detail of the present disclosure, within the scope of the present disclosure. Further, each example embodiment can be combined with another example embodiment, as appropriate.

Further, in a plurality of flowcharts used in the above description, a plurality of steps (pieces of processing) are described in order, but an execution order in which the steps are executed in each example embodiment is not limited to the described order. In each example embodiment, the order of the steps illustrated in the drawing can be changed within a range that does not hinder the contents.

A part or the entirety of the above-described example embodiment may be described as the following supplementary notes, but is not limited thereto.

1. An information output apparatus including:
a first acquisition unit that acquires subject information including a text;
a second acquisition unit that acquires attribute information of a user;
a third acquisition unit that inputs the attribute information and the subject information to a generative model, and acquires, from the generative model, provision information that is information based on the subject information and is to be provided to the user; and
an output unit that outputs the provision information.
   2. The information output apparatus according to supplementary note 1, in which
the provision information includes supplementary information supplementing the subject information.
   3. The information output apparatus according to supplementary note 2, in which
the output unit causes at least a part of the provision information and at least a part of the subject information to be displayed on a same screen.
   4. The information output apparatus according to supplementary note 1, in which
the provision information includes revised information revised from the subject information.
   5. The information output apparatus according to any one of supplementary notes 1 to 4, in which
the second acquisition unit updates at least a part of the attribute information to be used in next and subsequent times of processing, by using information being input by the user after the output unit outputs the provision information.
   6. The information output apparatus according to any one of supplementary notes 1 to 4, in which
the second acquisition unit acquires user information including at least one of information associated with an SNS account related to the user, a search log by the user, and a transaction history of the user, and generates the attribute information by using the acquired user information.
   7. The information output apparatus according to supplementary note 6, in which,
the second acquisition unit acquires the user information of each of a plurality of the users, and generates at least a part of the attribute information of at least one of the users by using the plurality of pieces of acquired user information.
   8. The information output apparatus according to supplementary note 6, in which
the user information includes a text, and
the second acquisition unit generates a related character string from a subject character string included in the text, and generates the attribute information by using the related character string.
   9. The information output apparatus according to any one of supplementary notes 1 to 8, in which
the subject information includes information published via a communication line.
   10. An information output method including,
by at least one computer:
   acquiring subject information including a text;
   acquiring attribute information of a user;
   inputting the attribute information and the subject information to a generative model, and acquiring, from the generative model, provision information that is information based on the subject information and is to be provided to the user; and
   outputting the provision information.
      11. A program causing at least one computer to include:
a first acquisition unit that acquires subject information including a text;
a second acquisition unit that acquires attribute information of a user;
a third acquisition unit that inputs the attribute information and the subject information to a generative model, and acquires, from the generative model, provision information that is information based on the subject information and is to be provided to the user; and
an output unit that outputs the provision information.

Further, some or all of the above-described configurations described in supplementary notes 2 to 9, being dependent from supplementary note 1, may also be dependent from supplementary notes 10 and 11 in a dependency relationship similar to that with supplementary note 1. Further, without being limited to supplementary notes 1, 10, and 11, as well, some or all of the configurations described as the supplementary notes may be dependent from various pieces of hardware, various pieces of software, various storage means for storing the software, or a system, without being deviated from each of the above-described example embodiments.
10 Information output apparatus
20 Communication apparatus
30 Search apparatus
110 First acquisition unit
120 Second acquisition unit
130 Third acquisition unit
140 Output unit

What is claimed is:

1. An information output apparatus comprising:
at least one memory configured to store instructions; and
at least one processor configured to execute the instruction to perform operations comprising:
acquiring subject information including a text;
acquiring attribute information of a user;
inputting the attribute information and the subject information to a generative model;
acquiring, from the generative model, provision information that is information based on the subject information and is to be provided to the user; and
outputting the provision information.

2. The information output apparatus according to claim 1, wherein
the provision information includes supplementary information supplementing the subject information.

3. The information output apparatus according to claim 2, wherein the operations further comprise
causing at least a part of the provision information and at least a part of the subject information to be displayed on a same screen.

4. The information output apparatus according to claim 1, wherein
the provision information includes revised information revised from the subject information.

5. The information output apparatus according to claim 1, wherein the operations further comprise
updating at least a part of the attribute information to be used in next and subsequent times of processing, by using information being input by the user after the provision information is output.

6. The information output apparatus according to claim 1, wherein the operations further comprise:
acquiring user information including at least one of information associated with an SNS account related to the user, a search log by the user, and a transaction history of the user; and
generating the attribute information by using the acquired user information.

7. The information output apparatus according to claim 6, wherein the operations further comprise:
acquiring the user information of each of a plurality of the users; and
generating at least a part of the attribute information of at least one of the users by using the plurality of pieces of acquired user information.

8. The information output apparatus according to claim 6, wherein
the user information includes a text, and
the operations further comprise:
generating a related character string from a subject character string included in the text; and
generating the attribute information by using the related character string.

9. An information output method comprising,
by at least one computer:
acquiring subject information including a text;
acquiring attribute information of a user;
inputting the attribute information and the subject information to a generative model;
acquiring, from the generative model, provision information that is information based on the subject information and is to be provided to the user; and
outputting the provision information.

10. A non-transitory computer-readable medium storing a program causing at least one computer to perform operations comprising:
acquiring subject information including a text;
acquiring attribute information of a user;
inputting the attribute information and the subject information to a generative model;
acquiring, from the generative model, provision information that is information based on the subject information and is to be provided to the user; and
outputting the provision information.
